(19) United States
(12) Patent Application Publication
(10) Pub. No.: US 2015/0096750 A1
(43) Pub. Date: Apr. 9, 2015

(54) HIGH INTERNAL PHASE RATIO INVERT EMULSION

(71) Applicants: M-I L.L.C., Houston, TX (US); Schlumberger Technology Corporation, Sugar Land, TX (US)

(72) Inventors: Anthony Loiseau, Sugar Land, TX (US); Hemant Kumar. J. Ladva, Missouri City, TX (US); Arvindbhai Patel, Houston, TX (US); Yiyan Chen, Sugar Land, TX (US)

(73) Assignees: M-I L.L.C., Houston, TX (US); Schlumberger Technology Corporation, Sugar Land, TX (US)

(21) Appl. No.: 14/049,930

(22) Filed: Oct. 9, 2013

(51) Int. Cl. C09K 8/36; C09K 8/584; E21B 33/12; C09K 8/80

(52) U.S. Cl. CPC C09K 8/36; C09K 8/80; C09K 8/584; E21B 33/12
USPC 166/280.2; 507/203; 507/250; 507/246

(57) ABSTRACT

A water-in-oil type emulsion having a dispersed particle volume fraction of greater than about 60 volume percent, based on the based on the total volume of the emulsion. Methods to produce the emulsion, treatment fluids comprising the emulsion, and uses thereof are also disclosed.

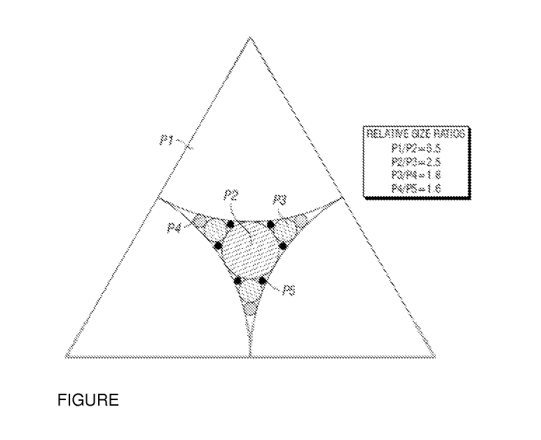

### BACKGROUND

Invert or water-in-oil emulsions are typically limited to less than 60% of an aqueous phase in an oil based phase in practice. The oil based continuous phase is expensive and may require additional steps and expense in use. Minimization of the amount of oil present in an invert emulsion is desirable. Accordingly, there is a demand for further improvements in this area of technology.

### SUMMARY

In some embodiments according to the present disclosure, a method comprises forming a composite emulsion comprising a plurality of particle size distribution modes of aqueous phase particles dispersed in an oil-based fluid, and manipulating the particle size distribution modes of the composite emulsion and a volume fraction of the oil-based fluid in the composite emulsion, to obtain high internal phase ratio invert emulsion comprising a dispersed particle volume fraction of greater than about 60 volume percent, based on the based on the total volume of the high internal phase ratio invert emulsion.

In embodiments, an emulsion comprises particles comprising an aqueous phase dispersed in an oil-based continuous phase and a surfactant system, the emulsion comprising a dispersed particle volume fraction of greater than about 60, greater than about 75 or even greater than about 90 volume percent, based on the total volume of the emulsion.

In embodiments, a method comprises combining various portions of an aqueous fluid with an oil-based fluid under different amounts of mixing energy, different surfactants, different surfactant concentrations, or a combination thereof, such as, for example, simultaneously increasing amounts of shear and increasing surfactant concentrations in successive additions of the aqueous fluid portions, to produce an emulsion comprising a particles of the aqueous fluid dispersed in the oil-based fluid having a plurality of particle size distribution modes, to produce an emulsion having a dispersed particle volume fraction of greater than about 60 volume percent, based on the total volume of the emulsion.

In embodiments, a method comprises combining amounts of individual emulsions, each comprising particles of an aqueous fluid dispersed in an oil-based fluid and a surfactant, and each having a different particle size distribution mode, to produce an intermediate emulsion; and removing at least a portion of the oil-based fluid from the intermediate emulsion in an amount sufficient to produce a final or subsequent emulsion comprising a dispersed particle volume fraction of greater than about 60 volume percent, based on the total volume of the final emulsion.

In embodiments, the method may comprise reversing the emulsion, for example, by contact with an acid or base to trigger reversion.

In embodiments, a treatment fluid comprises an emulsion comprising particles comprising an aqueous phase dispersed in an oil-based continuous phase and a surfactant system, the emulsion comprising a dispersed particle volume fraction of greater than about 60 volume percent, based on the total volume of the emulsion. In an embodiment, the invert emulsion or treatment fluid comprising the emulsion is reversible to form an oil-in-water emulsion.

### BRIEF DESCRIPTION OF THE DRAWING

The FIGURE illustrates a pentamodal Apollonian particle packing model based on the Descartes circle theorem involving mutually tangent circles, according to some embodiments of the current application.

### DETAILED DESCRIPTION

At the outset, it should be noted that in the development of any such actual embodiment, numerous implementation—specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

As used herein, “an embodiment” refers to non-limiting examples of the application disclosed herein, whether claimed or not, which may be employed or present alone or in any combination or permutation with one or more other embodiments. Each embodiment disclosed herein should be regarded both as an added feature to be used with one or more other embodiments, as well as an alternative to be used separately or in lieu of one or more other embodiments. It should be understood that no limitation of the scope of the claimed subject matter is thereby intended, any alterations and further modifications in the illustrated embodiment, and any further applications of the principles of the application as illustrated therein as would normally occur to one skilled in the art to which the disclosure relates are contemplated herein.

Moreover, the schematic illustrations and descriptions provided herein are understood to be examples only, and components and operations may be combined or divided, and added or removed, as well as re-ordered in whole or part, unless stated explicitly to the contrary herein.

It should be understood that, although a substantial portion of the following detailed description may be provided in the context of oilfield hydraulic fracturing operations, other oilfield operations such as cementing, gravel packing, treatment fluids, drilling fluids, and/or the like, as well as non-oilfield well treatment operations can utilize and benefit as well from the instant disclosure.

As used herein, the terms “treatment fluid” or “wellbore treatment fluid” are inclusive of “fracturing fluid” or “treatment slurry” and should be understood broadly. These may be or include a liquid, a solid, a gas, and combinations thereof, as will be appreciated by those skilled in the art. A treatment fluid may take the form of a solution, an emulsion, slurry, or any other form as will be appreciated by those skilled in the art.

The term “proppant” includes proppant or gravel used to hold fractures open and also includes gravel or proppant used in a gravel packing and/or a frac-pack operation.

“Carrier,” “fluid phase” or “liquid phase” refer to the fluid or liquid that is present as a continuous phase in the fluid. Reference to “aqueous phase” refers to a carrier phase comprised predominantly of water, which may be a continuous or dispersed phase. As used herein the terms “liquid” or “liquid phase” encompasses both liquids per se and supercritical fluids, including any solutes dissolved therein.

The terms “particulate”, “particle” and “particle size” used herein refer to discrete quantities of solids, gels, semi-solids, liquids, gases and/or foams unless otherwise specified.

As used herein, a blend of particles and a fluid may be generally referred to as a slurry, an emulsion, or the like. For purposes herein “slurry” refers to a mixture of solid particles dispersed in a fluid carrier. An “emulsion” refers to a form of slurry in which the particles are of a size such that the particles do not exhibit a static internal structure, but are assumed to be statistically distributed. In some embodiments, an emulsion is a mixture of two or more liquids that are normally immiscible (nonmixable or unblendable). For purposes herein, an emulsion comprises at least two phases of matter, which may be a first liquid phase dispersed in a continuous (second) liquid phase, and/or a first liquid phase and one or more solid phases dispersed in a continuous (second) liquid phase. Emulsions may be oil-in-water, water-in-oil, or any combination thereof, e.g., a “water-in-oil-in-water” emulsion or an “oil-in-water-in-oil” emulsion. For purposes herein, unless otherwise specified, the term “emulsion” includes both macro-emulsions and micro-emulsions. An average diameter of droplets in a macro-emulsion, is about 0.01 to about 1 mm. Micro-emulsions are typically isotropic and thermodynamically stable systems with dispersed domain diameters varying from about 0.1 nm to 100 nm, usually 10 to 50 nm. Accordingly, micro-emulsion implies an average diameter of droplets of the dispersed phase having diameters of 0.01 mm or less, or particles having an average particle size distribution in the range of about 0.001 mm to about 0.1 nm. The terms “flowable”, “pumpable” or “mixable” are used interchangeably herein and refer to a blend of particles and a liquid having either a yield stress or low-shear (5.11 s⁻¹) viscosity less than 1000 Pa and a dynamic apparent viscosity of less than 10 Pa-s (10,000 cP) at a shear rate 170 s⁻¹, where yield stress, low-shear viscosity and dynamic apparent viscosity are measured at a temperature of 25° C. unless another temperature is specified explicitly or in context of use.

Apollonian packing of spheres refers to the presence of successively smaller spheres to fit in the interstices of the larger spheres. For example, randomly packed monodisperse spheres, regardless of size, may have a packed volume fraction (PVF) of 0.64. By providing smaller spheres that can occupy the interstices between the larger spheres, the overall PVF can be increased. The FIGURE illustrates an approximate pentamodal Apollonian packing model obtained using the Descartes circle theorem. For four mutually tangent circles with curvatures Pₙ, Pₙ₊₁, Pₙ₊₂, Pₙ₊₃, the following equation (1) is applicable:

$$\frac{1}{{P}_{n}^{2}} + \frac{1}{{P}_{n + 1}^{2}} + \frac{1}{{P}_{n + 2}^{2}} + \frac{1}{{P}_{n + 3}^{2}} = \frac{1}{2} {( \frac{1}{{P}_{n}} + \frac{1}{{P}_{n + 1}} + \frac{1}{{P}_{n + 2}} + \frac{1}{{P}_{n + 3}} )}^{2} \qquad ( 1 )$$

where Pₙ is the curvature of circle n, where curvature is taken as the reciprocal of the radius. For example, when three equally sized spheres (Size P1=1) are touching each other, the size (diameter) ratio of P1/P2 can be obtained using the above equation to be 6.464˜6.5. Similarly, other ratios for successively smaller particle sizes required can be estimated as P2/P3 being about 2.5 and P3/P4 being about 1.8, and when a fifth particle is used, P4/P5 is about 1.6.

As used herein, the terms “Apollonianistic,” “Apollonianistic packing,” “Apollonianistic rule,” “Apollonianistic particle size distribution,” “Apollonianistic PSD” and similar terms, refer to a multimodal volume-averaged particle size distribution with particle size distribution (PSD) modes that are not necessarily strictly Apollonian wherein either (1) a first PSD mode comprises particulates having a volume-averaged median size (diameter) at least 1.5 times larger, or 3 times larger than the volume-average median size of at least a second PSD mode such that a packed volume fraction (PVF) of the particulates present in the mixture exceeds 0.75 or (2) the particle mixture comprises at least three PSD modes, wherein a first amount of particulates have a first PSD mode, a second amount of particulates have a second PSD mode, and a third amount of particulates have a third PSD mode, wherein the first PSD mode is from 1.5 to 25 times, or from 2 to 10 times larger than the second PSD mode, and wherein the second PSD mode is at least 1.5 times larger than the third PSD mode.

In a powder or particulated medium, the packed volume fraction (PVF) is defined as the volume of space occupied by the particles (the absolute volume) divided by the bulk volume, i.e., the total volume of the particles plus the void space between them:

PVF=Particle volume/(Particle volume+Non-particle Volume)=1−porosity

The porosity is thus the void fraction of the randomly packed particulates determined in the absence of overburden or other compressive forces that would deform the packed particulates. The PVF thus refers to the packing of particles (in the absence of overburden) based on a purely geometrical phenomenon. Therefore, the PVF depends only on the size and the shape of the particles present. The most ordered arrangement of monodisperse spheres (spheres with exactly the same size in a compact hexagonal packing) has a PVF of 0.74. However, such highly ordered arrangements of particles rarely occur in industrial operations. Rather, a somewhat random packing of particles is prevalent in oilfield treatment. Unless otherwise specified, particle packing in the current application means random packing of the particles. A random packing of the same spheres has a PVF of 0.64. In other words, the randomly packed particles occupy 64% of the bulk volume (i.e., Particle volume+Non-particle Volume), and the void space (i.e., porosity) occupies 36% of the bulk volume. A higher PVF can be achieved by preparing blends of the particles that have more than one particle size distribution mode and/or a range(s) of particle sizes, wherein the particle size distribution modes and relative proportions of each are selected such that the smaller particles fit in the void spaces between the larger particles, thus increasing the PVF of the particulates.

An Apollonianistic particle size distribution increases the PVF to above 0.74 by using a multimodal particle mixture, for example, coarse, medium and fine particles in specific volume ratios, where the smaller particles are selected to fit in the void spaces between the medium-size particles, and the medium size particles are selected to fit in the void space between the coarse particles. An Apollonianistic particle size distribution may, for example, include two consecutive particle size distribution classes or modes (PSD modes), the ratio between the mean particle diameters (d₅₀) of each mode may be between 1.5 and 25, or 3 and 20, or 7 and 10. In such cases, the PVF can increase up to 0.95. By blending coarse particles (such as proppant) with other particles selected to increase the PVF into a carrier fluid to produce a treatment fluid, only a minimum amount of the carrier fluid is needed to render the treatment fluid pumpable.

For purposes herein, the slurry solids volume fraction (SVF) refers to the volume fraction of solid particles dispersed in a fluid, which may be a continuous liquid phase or an emulsion comprising continuous and dispersed fluid phases, and is defined as the ratio of the volume fraction of all solid particulates, including the volume of any colloidal and/or submicron particles, relative to the total volume occupied by the particles and the fluid present: SVF=Solid Particle volume/(Solid Particle volume+Liquid volume).

For purposes herein, the internal phase ratio (IPR) refers to the volume of the internal phase fluid(s) relative to the total fluid volume (internal phase fluid volume+external or continuous phase fluid volume. In some embodiments, the emulsion may comprise an IPR of greater than about 60%, or at least 65%, or at least 70%, or at least 75%, or at least 80%, or at least 85%, or at least 90%, or at least 95%.

For purposes herein, the dispersed particle volume fraction (DPVF) refers to the volume of both solid and liquid dispersed particles, i.e., all dispersed particles including emulsified liquids, solids, colloidal solids, and the like, relative to the total volume occupied by the particles and the continuous phase: DPVF=(Solid Particle Volume+Internal Phase (Liquid Particle) Volume)/(Solid Particle Volume+Internal Phase Volume+Continuous or External Phase Volume). In some embodiments, the emulsion may comprise a DPVF of greater than about 60%, or at least 65%, or at least 70%, or at least 75%, or at least 80%, or at least 85%, or at least 90%, or at least 95%.

“Viscosity” as used herein unless otherwise indicated refers to the apparent dynamic viscosity of a fluid at a temperature of 25° C. and shear rate of 170 s⁻¹.

As used herein unless otherwise specified, particle size and particle size distribution (PSD) mode each refer to the median volume averaged size. The median size used herein may be any value understood in the art, including for example and without limitation a diameter of roughly spherical particulates. In embodiments, the median size may be a characteristic dimension, which may be a dimension considered most descriptive of the particles for specifying a size distribution range.

As used herein, the terms “bimodal” and “multimodal” with respect to particle size or other variable distribution have their standard statistical meanings. In statistics, a bimodal distribution is a continuous probability distribution with two different modes. A mixture is considered to be multimodal if it has two or more modes. These modes appear as distinct peaks (local maxima) in the probability density function. A bimodal distribution can arise as a mixture of two different unimodal distributions, i.e., distributions having one mode. For example, a bimodally distributed particle size can be defined as PSD₁ with probability α or PSD₂ with probability (1−α), where PSD₁ and PSD₂ are different unimodal particle sizes and 0<α<1 is a mixture coefficient. A mixture of two unimodal distributions with differing means is not necessarily bimodal; however, a mixture of two normal distributions with similar variability is considered to be bimodal if their respective means differ by more than the sum of their respective standard deviations.

As used herein, the term hydrocarbyl includes straight, branched and cyclic alkyl radicals comprising from 1 to 20 carbon atoms, aromatic radicals comprising from 6 to 20 carbon atoms, alkyl or aryl-substituted aromatic radicals comprising from 7 to 20 carbon atoms, halogenated radicals, various hydrocarbyl substituents, and the like. In addition two or more such radicals may together form a fused ring system, including partially or fully hydrogenated fused ring systems, or they may form a metallocycle with a metal. Suitable hydrocarbyl-substituted radicals include mono-, di- and tri-substituted functional groups, also referred to herein as radicals, comprising a Group 14 element, wherein each of the hydrocarbyl groups contains from 1 to 20 carbon atoms. Examples of the various hydrocarbyl substituents include substituents comprising Group 15 and/or Group 16 heteroatoms. Other functional groups suitable for use as substituents include organic and inorganic radicals, wherein each of the functional groups comprises hydrogen, and atoms from Groups 13, 14, 15, 16, and/or 17, preferably 1 to 20 carbon atoms, oxygen, sulfur, phosphorous, silicon, selenium, or a combination thereof. In addition, functional groups may include one or more functional group substituted with one or more additional functional groups. Examples of functional groups included in the term hydrocarbyl include amines, phosphines, ethers, esters, thioethers, alcohols, amides, and/or derivatives thereof.

In embodiments, an emulsion comprises an aqueous phase dispersed in an oil-based continuous phase and a surfactant system, the emulsion comprising a dispersed particle volume fraction of greater than about 60 volume percent, based on the total volume of the emulsion.

In embodiments, the particles comprise a plurality of particle size distribution modes, wherein a first particle size distribution mode is from about 1.5 to 25 times larger than a second particle size distribution mode. In embodiments, the emulsion comprises a dispersed particle volume fraction of greater than or equal to about 75 volume percent, based on the total volume of the emulsion. In embodiments, the emulsion comprises a dispersed particle volume fraction of greater than or equal to about 90 volume percent, based on the total volume of the emulsion. In embodiments, the particles may comprise deformable droplets to achieve higher packing and thus, an increased dispersed particle volume fraction.

In embodiments, the emulsion comprises from about 0.1 to about 20 weight percent of the surfactant system, wherein the surfactant system comprises an amine surfactant having the structure:

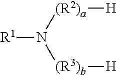

wherein R¹ is a hydrocarbyl comprising from 8 to 24 carbon atoms; wherein R² and R³ are independently selected from substituted or unsubstituted hydrocarbyl radicals comprising from 1 to 10 carbon atoms, ethylene oxide, propylene oxide, or a combination thereof; and wherein a+b is greater than or equal to 2.

In embodiments, a method comprises forming a composite emulsion comprising a plurality of particle size distribution modes of aqueous phase particles dispersed in an oil-based fluid; and manipulating the particle size distribution modes of the composite emulsion and a volume fraction of the oil-based fluid in the composite emulsion, to obtain high internal phase ratio invert emulsion comprising a dispersed particle volume fraction of greater than about 60 volume percent, based on the based on the total volume of the high internal phase ratio invert emulsion.

In embodiments, the method may comprise removing a portion of the oil-based fluid from the composite emulsion to increase a dispersed particle volume fraction in the high internal phase ratio invert emulsion. For example, the method may comprise combining a plurality of water-in-oil emulsions, each combined emulsion comprising one or more of the plurality of particle size distribution modes to form the composite emulsion; and removing a portion of the oil-based fluid from the composite emulsion to increase a dispersed particle volume fraction in the high internal phase ratio invert emulsion.

In embodiments, the method may comprise dispersing oil-based fluid in the aqueous phase of one or more of the particle size distribution modes, wherein the high internal phase ratio invert emulsion comprises an oil-in-water-in-oil emulsion.

In embodiments, the method may comprise combining an initial aqueous fluid portion with at least a portion of the oil-based fluid in the presence of an initial surfactant system under an initial amount of mixing energy to produce an initial emulsion comprising aqueous fluid particles having an initial particle size distribution mode dispersed in the oil-based fluid, combining a first successive aqueous fluid portion with the initial emulsion in the presence of a first successive surfactant system under a first successive amount of mixing energy to produce a first successive composite emulsion comprising aqueous fluid particles having a first successive particle size distribution mode dispersed in the oil-based fluid, and selecting the initial and first successive surfactant systems and amounts of mixing energy to produce successively larger particle size distribution modes from the initial emulsion to the first successive composite emulsion. In further embodiments, the method may comprise combining one or more subsequent successive aqueous fluid portions with a respective immediately preceding one of the first or subsequent successive composite emulsions, in the presence of one or more respective subsequent successive surfactant systems under one or more respective subsequent successive amounts of mixing energy, to produce the respective one of the one or more subsequent successive composite emulsions, each comprising aqueous fluid particles having a respective subsequent successive particle size distribution mode dispersed in the oil-based fluid, and selecting the one or more subsequent successive surfactant systems and amounts of mixing energy to produce successively larger particle size distribution modes from the first successive composite emulsion to an ultimate one of the one or more subsequent successive composite emulsions.

In embodiments, the method may comprise removing a portion of the oil-based fluid from one of the initial or first or subsequent successive emulsions or a combination thereof to increase a dispersed particle volume fraction in the respective initial, first or subsequent successive emulsion. In some embodiments, each of the first and subsequent successive particle size distribution modes is from about 1.5 to 25 times larger than the respective one of the next preceding initial, first and subsequent successive particle size distribution modes. In some embodiments, the high internal phase ratio invert emulsion comprises a dispersed particle volume fraction of greater than about 90 volume percent, based on the based on the total volume of the emulsion.

In embodiments, the method may comprise one or more of the initial and first and subsequent successive surfactant systems comprise from about 0.1 to about 20 weight percent, by weight of the respective one of the initial and first and subsequent successive emulsions, of an amine surfactant having the structure:

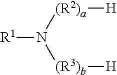

wherein R¹ is a hydrocarbyl comprising from 8 to 24 carbon atoms; wherein R² and R³ are independently selected from substituted or unsubstituted hydrocarbyl radicals comprising from 1 to 10 carbon atoms, ethylene oxide, propylene oxide, or a combination thereof; and wherein a+b is greater than or equal to 2.

In embodiments, one or more of the initial and first and subsequent successive surfactant systems comprise surfactant components differing from those of another one of the initial and first and subsequent successive surfactant systems.

In embodiments, the method may comprise reversing the invert emulsion to form an oil-in-water emulsion.

In embodiments, the method may comprise introducing a proppant into the composite emulsion to produce a treatment fluid comprising the proppant dispersed in the high internal phase ratio invert emulsion; and circulating the treatment fluid into a wellbore. In some embodiments, the method may further comprise forming a pack downhole comprising the proppant and at least a portion of the aqueous phase particles. In some embodiments, the method may further comprise contacting the pack with an acid in an amount sufficient to at least partially remove the aqueous phase particles from the pack to form a permeable pack; and producing a reservoir fluid or injecting an injection fluid through the permeable pack. In embodiments, the method may comprise reversing the invert emulsion to form an oil-in-water emulsion, either before or after forming the pack.

In embodiments, a treatment fluid comprises the high internal phase ratio invert emulsion produced by any of the methods described herein. In embodiments, the treatment fluid may reversible to form an oil-in-water emulsion.

In embodiments, an emulsion comprises aqueous phase particles dispersed in a continuous oil-based phase and a surfactant system, the emulsion comprising a dispersed particle volume fraction of greater than about 60 volume percent, based on the based on the total volume of the emulsion. In embodiments, the emulsion may comprise an internal oil-based phase dispersed in the aqueous phase to form an oil-in-water-in emulsion. In embodiments, the aqueous fluid particles comprise a plurality of particle size distribution modes, wherein a first particle size distribution mode is from about 1.5 to 25 times larger than a second particle size distribution mode. In embodiments the emulsion may be reversible.

In embodiments, a treatment fluid comprises proppant dispersed in an emulsion comprising aqueous phase particles dispersed in a continuous oil-based phase and a surfactant system, the emulsion comprising a dispersed particle volume fraction of greater than about 60 volume percent, based on the based on the total volume of the emulsion.

In embodiments, an emulsion comprises an aqueous phase dispersed in an oil-based continuous phase and a surfactant system. In embodiments, the emulsion comprises a dispersed particle volume fraction of greater than about 60 volume percent, based on the total volume of the emulsion. In embodiments, the emulsion comprises a dispersed particle volume fraction of greater than or equal to about 65 volume percent, or greater than or equal to about 70 volume percent, or greater than or equal to about 75 volume percent, or greater than or equal to about 80 volume percent, or greater than or equal to about 85 volume percent, or greater than or equal to about 90 volume percent, or greater than or equal to about 95 volume percent, based on the total volume of the emulsion. In embodiments, the emulsion comprises a dispersed particle volume fraction of greater than about 60 volume percent, based on the total volume of the emulsion. In embodiments, the emulsion comprises an internal phase ratio of greater than or equal to about 65 volume percent, or greater than or equal to about 70 volume percent, or greater than or equal to about 75 volume percent, or greater than or equal to about 80 volume percent, or greater than or equal to about 85 volume percent, or greater than or equal to about 90 volume percent, or greater than or equal to about 95 volume percent, based on the total volume of the emulsion.

In embodiments, the emulsion, or a treatment fluid comprising the emulsion, comprises aqueous fluid particles comprising a plurality of particle size distribution modes, wherein each successively larger particle size distribution mode (PSD mode) is from about 1.5 to 25 times larger than a next smaller PSD mode. In embodiments, the successively larger PSD modes comprise particulates having a volume-averaged median size at least 1.5 times larger, or 3 times larger than the volume-average median size of the next smaller PSD mode such that a DPVF exceeds 0.6 (i.e., 60 volume percent). In embodiments, the emulsion, or a treatment fluid comprising the emulsion, may comprise at least three PSD modes, wherein a first amount of particulates have a first PSD mode, a second amount of particulates have a second PSD mode, and a third amount of the particles have a third PSD mode, wherein the first PSD mode is from 1.5 to 25 times, or from 2 to 10 times larger than the second PSD mode, and wherein the second PSD mode is at least 1.5 times larger than the third PSD mode. In embodiments, the emulsion, or a treatment fluid comprising the emulsion, further comprises particles other than the emulsion particles comprising the aqueous fluid.

In embodiments, the emulsion, or a treatment fluid comprising the emulsion, comprises a four or more PSD modes, wherein a first amount of particulates have a first PSD mode, a second amount of particulates have a second PSD mode, a third amount of particulates have a third PSD mode, and a fourth amount of particulates have a fourth PSD mode, and so on, wherein the first PSD mode is at least three times larger than the second PSD mode, wherein the second PSD mode is larger than the third PSD mode, or at least 1.5 or at least three times larger than the third PSD mode, and wherein the third PSD mode is larger than the fourth PSD mode, or from three to fifteen times larger than the fourth PSD mode, and so on for emulsions or treatment fluids comprising five or more PSD modes. In embodiments, a ratio of the total particle volume of the first particles to the total particle volume of the second particles is from about 1:1 to about 15:1, or from about 2:1 to about 10:1 or from about 4:1 to about 8:1; and a ratio of the total particle volume of the second particles to the total particle volume of the third particles is from about 1:10 to about 2:1, or from about 1:4 to about 1:1.

In embodiments, the emulsion or a treatment fluid comprising the emulsion may comprise particles having a second PSD mode comprising from 5 to 30 vol %, or from 10 to 20 vol %, or from 10 to 15 vol % of the dispersed particle volume fraction occupied by a particles having a first PSD mode; and/or a third PSD mode comprising from about 3 to 20 vol %, or from 3 to 10 vol % of the dispersed particle volume fraction of the first PSD mode; and/or a fourth PSD mode, if present, comprising from about 5 to 40 vol %, or from 10 to 30 vol % of the dispersed particle volume fraction of the first PSD mode; and/or the fifth PSD mode, if present, comprising a volume fraction from about 1 to 40 vol % of the dispersed volume fraction of the first PSD mode, wherein at least one PSD mode comprises particles comprising the aqueous phase dispersed in the oil based continuous phase.

In embodiments, the emulsion or a treatment fluid comprising the emulsion may include particles suitable for use in a treatment fluid as a fluid loss control agent that inhibits fluid loss at a formation face, screen or other potentially fluid permeable surface. The fluid loss control agent in various embodiments is useful in a wide variety of treatment fluids including by way of example and not limitation, drilling fluids, completion fluids, stimulating fluids, including fracing fluids, gravel packing fluids, frac-packing fluids, whether containing solids or slick water, pads, flushes, spacers, and the like.

In embodiments, the emulsion or a treatment fluid comprising the emulsion may include particles comprising ground quartz, oil soluble resin, degradable rock salt, clay, zeolite, magnesium hydroxide, magnesium carbonate, magnesium calcium carbonate, calcium carbonate, aluminum hydroxide, calcium oxalate, calcium phosphate, aluminum metaphosphate, sodium zinc potassium polyphosphate glass, sodium calcium magnesium polyphosphate glass, and/or the like.

In embodiments, the emulsion or a treatment fluid comprising the emulsion may further include a fluid loss control agent, a leak-off control agent, a stability agent, a dispersant, a co-solvent, an energizing agent, a viscosifier, a crosslinker, a friction reducer, a breaker, an accelerator, a retarder, an antioxidant, a pH stabilizer, a control agent, and/or the like.

In embodiments, the emulsion comprises one or more surfactant systems suitable to stabilize the particles under conditions consistent with the intended use. In embodiments, the surfactant system is reversible, meaning that contact of emulsion in general, and the surfactant system in particular, with a reversing agent causes at least a portion of the emulsion to reverse from a water-in-oil emulsion into an oil-in-water emulsion, or to simply destroy the particles such that the discrete particles are destroyed. In embodiments, the reversing agent may be an acid or a base, thus a reversing agent may affect the pH of the emulsion to facilitate the reversion thereof.

In embodiments, the surfactant system comprises an amine surfactant having the structure:

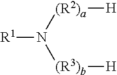

wherein R¹ is a hydrocarbyl comprising from 8 to 24 carbon atoms; wherein R² and R³ are independently selected from substituted or unsubstituted hydrocarbyl radicals comprising from 1 to 10 carbon atoms, ethylene oxide, propylene oxide, or a combination thereof; and wherein a+b is greater than or equal to 2. In embodiments, the amine surfactant comprises from about 2 to about 30 moles of ethylene oxide, propylene oxide, or a combination thereof.

In embodiments, the amine surfactant comprises an ethoxylated tallow amine; soya amine; N-alkyl-1,3-diaminopropane, wherein the alkyl is a hydrocarbon comprising from 12 to 22 carbon atoms; or a combination thereof. In embodiments, the amine surfactant comprises from about 2 to about 30 moles of ethylene oxide, propylene oxide, or a combination thereof. In embodiments, the amine surfactant comprises from 2 to 20 moles of ethylene oxide.

Suitable examples of surfactant systems include those disclosed in U.S. Pat. No. 6,218,342 and its progeny, U.S. Pat. No. 6,806,233 and its progeny, U.S. Pat. No. 6,989,354 and its progeny, U.S. Pat. No. 7,125,826 and its progeny, all of which are herein incorporated by reference in their entirety. Suitable examples of surfactant systems further include the surfactant systems utilized in FAZEPRO™ (M-I SWACO, Houston, Tex.) which is a reversible oil-based invert emulsion drilling fluid.

In embodiments, emulsion or a treatment fluid comprising the emulsion comprises from about 0.1 to about 20 wt % of the surfactant system. In embodiments, the emulsion or a treatment fluid comprising the emulsion comprises about 0.5 to about 15 wt %, or about 1 to about 10 wt %, or about 2 to about 5 wt % of the surfactant system.

In embodiments, the emulsion or a treatment fluid comprising the emulsion may comprise one or more buffer systems. Suitable buffer systems include buffer systems comprising triethanolamine, sodium hydroxide, sodium acetate, and/or sodium bicarbonate. Other examples of suitable buffer systems include carbonic acid/potassium carbonate, phosphoric acid/potassium or sodium phosphate, acetic acid/sodium acetate. In embodiments, the buffer system includes, without limitation: phosphate buffers; sulfate buffers; acetic/acetate buffers; mono- and polycarboxylic acid buffers comprising from 1 to 10 carbon atoms; substituted carboxylic acids such as lactic, ascorbic, and tartaric acid buffers; and carboxylic acids that have unsaturation such as maleic and fumaric buffers, and the like.

In embodiments, the surfactant system, the buffer system and/or the concentration of the buffer may be selected according to the indigenous fluid present in a particular well bore, and/or according to the desired period of time required to at least partially invert the emulsion.

In embodiments, the emulsion comprises greater than about 40 vol % of an aqueous fluid as the discontinuous or dispersed phase. In embodiments, the emulsion comprises greater than or equal to about 45 vol %, or greater than or equal to about 50 vol %, or greater than or equal to about 55 vol %, or greater than or equal to about 60 vol %, or greater than or equal to about 65 vol %, or greater than or equal to about 70 vol %, or greater than or equal to about 75 vol %, or greater than or equal to about 80 vol %, or greater than or equal to about 85 vol %, or greater than or equal to about 90 vol %, and less than or equal to about 95 vol % of the aqueous fluid. In embodiments, the aqueous fluid is water, sea water, a brine comprising organic or inorganic dissolved salts, or a combination thereof.

In embodiments, the emulsion comprises from about 5 vol % to about 40 vol % of an oil-based or oleaginous fluid. In embodiments, the oleaginous fluid may comprise diesel oil, kerosene, paraffinic oil, crude oil, LPG, toluene, xylene, ether, ester, mineral oil, biodiesel, vegetable oil, animal oil, acetone, acetonitrile, benzene, 1-butanol, 2-butanol, 2-butanone, t-butyl alcohol, carbon tetrachloride, chlorobenzene, chloroform, cyclohexane, 1,2-dichloroethane, diethyl ether, diethylene glycol, diglyme (diethylene glycol dimethyl ether), 1,2-dimethoxy-ethane (glyme, DME), dimethylether, dibuthylether, dimethyl-formamide (DMF), dimethyl sulfoxide (DMSO), dioxane, ethanol, ethyl acetate, ethylene glycol, glycerin, heptanes, hexamethylphosphoramide (HMPA), hexamethylphosphorous triamide (HMPT), hexane, methanol, methyl t-butyl ether (MTBE), methylene chloride, N-methyl-2-pyrrolidinone (NMP), nitromethane, pentane, Petroleum ether (ligroine), 1-propanol, 2-propanol, pyridine, tetrahydrofuran (THF), toluene, triethyl amine, o-xylene, m-xylene, p-xylene, or mixtures thereof.

In embodiments, the oleaginous fluid may include a degradable oleaginous fluid. In embodiments, the degradable oleaginous fluid is selected from the group consisting of an oleophilic monocarboxylic acid ester comprising from 3 to 40 carbon atoms, an oleophilic polycarboxylic acid ester comprising from 3 to 40 carbon atoms, an oleophilic ether comprising from 3 to 40 carbon atoms, an oleophilic alcohol comprising from 3 to 40 carbon atoms, and combinations thereof. In embodiments, the degradable oleaginous fluid is non-toxicological.

Suitable degradable oleaginous fluids include FlexiSOLV® dibutyl ester (DBE) (INVISTA, Koch Industries, USA), which are high boiling oxygenated solvents that are miscible with organic solvents, low odor and flammability, comprising refined dimethyl esters of adipic, glutaric and succinic acids. The DBE esters undergo reactions expected of the ester group such as hydrolysis and transesterification. At low and high pH the DBE esters are hydrolyzed to the corresponding acids, their salts and alcohol. The dibutyl ester components of dimethyl succinate, dimethyl glutarate and dimethyl adipate are readily biodegradable.

In embodiments, the oleaginous fluid may include aromatic petroleum cuts, terpenes, mono-, di- and tri-glycerides of saturated or unsaturated fatty acids including natural and synthetic triglycerides, aliphatic esters such as methyl esters of a mixture of acetic, succinic and glutaric acids, aliphatic ethers of glycols such as ethylene glycol monobutyl ether, minerals oils such as VASELINE oil, chlorinated solvents like 1,1,1-trichloroethane, perchloroethylene and methylene chloride, deodorized kerosene, solvent naphtha, paraffins (including linear paraffins), isoparaffins, olefins (especially linear olefins) and aliphatic or aromatic hydrocarbons (such as toluene). Terpenes are suitable, including d-limonene, 1-limonene, dipentene (also known as 1-methyl-4-(1-methylethenyl)-cyclohexene), myrcene, alpha-pinene, linalool and mixtures thereof.

Further exemplary oleaginous liquids include long chain alcohols (monoalcohols and glycols), esters, ketones (including diketones and polyketones), nitrites, amides, amines, cyclic ethers, linear and branched ethers, glycol ethers (such as ethylene glycol monobutyl ether), polyglycol ethers, pyrrolidones like N-(alkyl or cycloalkyl)-2-pyrrolidones, N-alkyl piperidones, N,N-dialkyl alkanolamides, N,N,N′,N′-tetra alkyl ureas, dialkylsulfoxides, pyridines, hexaalkylphosphoric triamides, 1,3-dimethyl-2-imidazolidinone, nitroalkanes, nitro-compounds of aromatic hydrocarbons, sulfolanes, butyrolactones, and alkylene or alkyl carbonates. These include polyalkylene glycols, polyalkylene glycol ethers like mono (alkyl or aryl)ethers of glycols, mono (alkyl or aryl)ethers of polyalkylene glycols and poly (alkyl and/or aryl) ethers of polyalkylene glycols, monoalkanoate esters of glycols, monoalkanoate esters of polyalkylene glycols, polyalkylene glycol esters like poly (alkyl and/or aryl) esters of polyalkylene glycols, dialkyl ethers of polyalkylene glycols, dialkanoate esters of polyalkylene glycols, N-(alkyl or cycloalkyl)-2-pyrrolidones, pyridine and alkylpyridines, diethylether, dimethoxyethane, methyl formate, ethyl formate, methyl propionate, acetonitrile, benzonitrile, dimethylformamide, N-methylpyrrolidone, ethylene carbonate, dimethyl carbonate, propylene carbonate, diethyl carbonate, ethylmethyl carbonate, and dibutyl carbonate, lactones, nitromethane, and nitrobenzene sulfones. The oleaginous liquid may also include tetrahydrofuran, dioxane, dioxolane, methyltetrahydrofuran, dimethylsulfone, tetramethylene sulfone and thiophene.

In embodiments, the emulsion may be a treatment fluid, or be combined with a carrier fluid and/or with a proppant and/or a gravel packing fluid, base fracturing fluid, and/or the like, to produce a treatment fluid. Some non-limiting examples of carrier and other fluids include hydratable gels (e.g. guars, poly-saccharides, xanthan, hydroxy-ethyl-cellulose, etc.), a crosslinked hydratable gel, a viscosified acid (e.g. gel-based), an emulsified acid (e.g. oil outer phase), an energized fluid (e.g. an N₂ or CO₂ based foam), and an oil-based fluid including a gelled, foamed, or otherwise viscosified oil. Additionally, the carrier fluid may be a brine, and/or may include a brine.

In embodiments, the emulsion may comprise an acid, and/or may be reversed by contact with an acid. The acid may include hydrochloric acid, hydrofluoric acid, ammonium bifluoride, formic acid, acetic acid, lactic acid, glycolic acid, maleic acid, tartaric acid, sulfamic acid, malic acid, citric acid, methyl-sulfamic acid, chloro-acetic acid, an amino-poly-carboxylic acid, 3-hydroxypropionic acid, a poly-amino-poly-carboxylic acid, and/or a salt of any acid. In embodiments, the carrier fluid includes a poly-amino-poly-carboxylic acid, and is a trisodium hydroxyl-ethyl-ethylene-diamine triacetate, mono-ammonium salts of hydroxyl-ethyl-ethylene-diamine triacetate, and/or mono-sodium salts of hydroxyl-ethyl-ethylene-diamine tetra-acetate. The selection of any acid as a carrier fluid depends upon the purpose of the acid—for example formation etching, damage cleanup, removal of acid-reactive particles, etc., and further upon compatibility with the formation, compatibility with fluids in the formation, and compatibility with other components of the fracturing slurry and with spacer fluids or other fluids that may be present in the wellbore. The selection of an acid for the carrier fluid is understood in the art based upon the characteristics of particular embodiments and the disclosures herein.

In embodiments, the emulsion may be combined with a carrier fluid and/or other particulates such as a proppant, to produce a treatment fluid. In embodiments, the treatment fluid comprising the emulsion may further comprise a particulate blend comprising various solids including a proppant. Suitable proppants include natural or synthetic materials, including but not limited to glass beads, ceramic beads, sand, and bauxite, coated, or contain chemicals; more than one can be used sequentially or in mixtures of different sizes or different materials. The proppant may be resin coated (curable), or pre-cured resin coated. Proppants and gravels in the same or different wells or treatments can be the same material and/or the same size as one another and the term proppant is intended to include gravel in this disclosure. In some embodiments, irregular shaped particles may be used such as unconventional proppant.

In general the proppant used may have an average particle size of from about 0.15 mm to about 4.76 mm (about 100 to about 4 U.S. mesh), or from about 0.15 mm to about 3.36 mm (about 100 to about 6 mesh), or from about 0.15 mm to about 4.76 mm (about 100 to about 4 mesh), or from about 0.25 to 0.42 mm (about 40 to 60 mesh), or 0.42 to 0.84 mm (about 20 to 40 mesh), or 0.84 to 1.19 mm (about 16 to 20 mesh), or 0.84 to 1.68 mm (about 12 to 20 mesh) or 0.84 to 2.38 mm (about 8 to 20 mesh), or combinations thereof.

The treatment fluid may further comprise particulate materials with defined particles size distribution modes. Examples of high solid content treatment carrier fluid (HSCF) in which one or more embodiments of the emulsion disclosed herein may be employed are disclosed in U.S. Pat. No. 7,789,146; U.S. Pat. No. 7,784,541; U.S. Pat. No. 8,119,574, U.S. Pat. No. 8,008,234, 2011/0155372; US 2011/0243250; and US 2011/0300688; and their progeny, all of which are hereby incorporated herein by reference in their entireties.

In embodiments, the treatment fluid may further comprise a degradable material. In embodiments, the degradable material includes at least one of a lactide, a glycolide, an aliphatic polyester, a poly (lactide), a poly (glycolide), a poly (E-caprolactone), a poly (orthoester), a poly (hydroxybutyrate), an aliphatic polycarbonate, a poly (phosphazene), and a poly (anhydride). In embodiments, the degradable material includes at least one of a poly (saccharide), dextran, cellulose, chitin, chitosan, a protein, a poly (amino acid), a poly (ethylene oxide), and a copolymer including poly (lactic acid) and poly (glycolic acid). In embodiments, the degradable material includes a copolymer including a first moiety which includes at least one functional group from a hydroxyl group, a carboxylic acid group, and a hydrocarboxylic acid group, the copolymer further including a second moiety comprising at least one of glycolic acid and lactic acid.

In some embodiments, the treatment fluid may optionally further comprise additional additives, including, but not limited to, acids, fluid loss control additives, gas, corrosion inhibitors, scale inhibitors, catalysts, clay control agents, biocides, friction reducers, combinations thereof and the like.

The treatment fluids comprising one or more embodiments of the emulsion disclosed herein may be used for carrying out a variety of subterranean treatments, including, but not limited to, drilling operations, fracturing treatments, and completion operations (e.g., gravel packing). In some embodiments, the treatment fluid may be used in treating a portion of a subterranean formation. In embodiments, the treatment fluid may be introduced into a well bore that penetrates the subterranean formation as a treatment fluid. For example, the treatment fluid may be allowed to contact the subterranean formation for a period of time. In some embodiments, the treatment fluid may be allowed to contact hydrocarbons, formations fluids, and/or subsequently injected treatment fluids. After a chosen time, the treatment fluid may be recovered through the well bore. In embodiments, the treatment fluids may be used in fracturing treatments.

In embodiments, the treatment fluid may also be suitable for gravel packing, or for fracturing and gravel packing in one operation (called, for example frac and pack, frac-n-pack, frac-pack, STIMPAC (Trade Mark from Schlumberger) treatments, or other names), which are also used extensively to stimulate the production of hydrocarbons, water and other fluids from subterranean formations. These operations involve pumping the composition and propping agent/material in hydraulic fracturing or gravel (materials are generally as the proppants used in hydraulic fracturing) in gravel packing. In low permeability formations, the goal of hydraulic fracturing is generally to form long, high surface area fractures that greatly increase the magnitude of the pathway of fluid flow from the formation to the wellbore. In high permeability formations, the goal of a hydraulic fracturing treatment is typically to create a short, wide, highly conductive fracture, in order to bypass near-wellbore damage done in drilling and/or completion, to ensure good fluid communication between the reservoir and the wellbore and also to increase the surface area available for fluids to flow into the wellbore.

In embodiments, a wellbore may be gravel packed or otherwise serviced with a proppant. In embodiments, the displacement fluid and the gravel carrier fluid may have a density equivalent to or greater than the formation pore pressure to prevent a well control event. In embodiments, when gravel packing such a well/formation the original drilling fluid depositing the filter cake may comprise particles of the emulsion disclosed herein. In embodiments, the emulsion is contacted with a reversing agent under conditions sufficient to reverse the emulsion, rendering the filter cake or other pack water wet or dispersible and thus removal from the wellbore. In some embodiments, the invert emulsion with a high internal phase ratio may be used in one step or stage or phase of a treatment method where an oil external phase is desired, e.g., in contact with water-sensitive shales, and following reversion to an oil-in-water emulsion, used in another step or stage or phase of a treatment method where a water external phase is desired, e.g., to disperse a filter cake or the like.

In embodiments, the emulsion dispersed in a treatment fluid may provide at least one particle size distribution mode of the treatment fluid comprising an Apollonianistic particle size distribution comprising a carrier fluid combined with a first, second, and third amount of particles in a slurry or other emulsion. The particulates in embodiments comprise three size regimes or PSD's, wherein each size regime is larger than the next smaller size regime. The inclusion of varying size particulates with a high particulate loading creates a slurry with greatly reduced settling times relative to a slurry with a uniform particle size.

In embodiments, a method to produce an emulsion according to any one or combination of embodiments disclosed herein comprises combining a first portion of an aqueous fluid having a first composition with an oil-based fluid in the presence of a first surfactant system under a first amount of mixing to produce an intermediate emulsion comprising the aqueous fluid having a first particle size distribution mode dispersed in the oil-based fluid; combining a (second) portion of the aqueous fluid having a second composition and a second surfactant system with the intermediate emulsion under a second amount of mixing in to produce particles comprising the aqueous fluid having a second particle size distribution mode which is larger than the first particle size distribution mode, to produce an emulsion comprising a dispersed particle volume fraction of greater than about 60 volume percent, based on the total volume of the emulsion. In embodiments, the first surfactant system is identical to the second surfactant system and/or the first composition (of the aqueous fluid) is identical to the second composition (of the aqueous fluid). In other words, in embodiments, additional surfactant system may be added, another surfactant system may be added, or no additional surfactant system may be added upon addition of the second portion of the aqueous fluid, and/or the composition of the aqueous fluid may be changed (e.g., having different densities, having different components, having different relative concentrations of the same components, and/or the like) under different mixing conditions to produce the second particle size distribution.

In embodiments, the first particle size distribution mode is from about 1.5 to 25 times larger than the second particle size distribution mode. In embodiments, the emulsion comprises a dispersed particle volume fraction of greater than or equal to about 90 volume percent, based on the total volume of the emulsion.

The particle size of the emulsified aqueous phase is proportional to the amount of shear, or the amount of mixing energy employed in forming the particles, along with the type of surfactant used, the compositions of the various phases, the interfacial surface tension of the aqueous phase and the oil-based phase, as well as a host of other variables. For purposes herein, mixing refers to the average amount of shear, the duration of mixing or the total amount of shear, the instantaneous energy imparted into the mixture (e.g., tip speed, Reynolds number, and/or the like), the total amount of energy imparted into the mixture, and/or the like. The amount of mixing energy refers to the product of the instantaneous energy imparted to the mixture times the duration of the energy input. Accordingly, by incorporating the aqueous phase into the emulsion under a plurality of shear or other mixing conditions, particles having different PSD modes may be formed in a single emulsion. In embodiments, the densities of the various phases and thus the compositions may also be modified as part of the mixing conditions to produce one or more of the different PSD modes present in a single emulsion.

In addition, since the maximum dispersed particle volume fraction obtainable in practice by a single PSD mode of particles is less than about 60 vol %, while theoretically possible, in practice, it can be difficult to combine a plurality of single PSD mode emulsions to produce an emulsion having a dispersed particle volume fraction of greater than 60 vol %. However, by combining a plurality of single PSD mode emulsions and subsequently removing a portion of the continuous phase, e.g., by filtering the emulsion and removing a portion of the filtrate while retaining the particulates, by evaporating a portion of the continuous phase, by dialysis or use of other selective membranes, and/or the like, it is possible to produce an emulsion as disclosed herein. Accordingly, in embodiments, a method comprises combining an amount of a first emulsion comprising a first aqueous fluid dispersed in an oil-based fluid and a first surfactant system, and having a first particle size distribution mode with an amount of a second emulsion comprising a second aqueous fluid dispersed in the oil-based fluid and a second surfactant system, and having a second particle size distribution mode to produce an intermediate emulsion; and removing at least a portion of the oil-based fluid from the intermediate emulsion in an amount sufficient to produce a third emulsion comprising a dispersed particle volume fraction of greater than about 60 volume percent, based on the total volume of the emulsion. In embodiments, the first surfactant system and the second surfactant system are identical and/or the first aqueous fluid and the second aqueous fluid are identical.

In embodiments, different particle size distributions of the dispersed phase liquid may be obtained by subjecting a mixture of the continuous phase liquid and the dispersed phase liquid to different rates and/or amounts of shear in the presence of selected surfactant(s). Since the size of the dispersed particles that are formed is generally a function of the shear rate, and/or duration, wherein a higher shear rate or duration leads to smaller particles, the particle size of the droplets may be varied by varying the shear rate and/or duration accordingly. Further, after a droplet has been reduced in size by subjecting the mixture of liquids to a relatively high rate of shear, thereafter subjecting the mixture to a lesser amount of shear in some embodiments may have no or little effect on the high-shear, small-size particles, e.g., once formed the smaller particles do not change size at lower rates of shear. In these embodiments, the high IPR emulsion may be formed by mixing the internal phase liquid in stages beginning with a high rate of shear to mix in an initial amount of the internal phase liquid added to the external phase liquid, then adding a second amount of the internal phase liquid, or a modified second amount of the internal phase liquid e.g., having a different density or composition, and optionally more of the same surfactant system or a second surfactant system, with a lower intermediate rate of shear, e.g., a reduced pump or impeller speed, to make relatively intermediate size droplets mixed with the small, high-shear droplets of the first amount of internal phase liquid, thereafter mixing in a third amount of internal phase liquid at a relatively lower rate of shear to form relatively larger internal phase droplets, and so on until the number of particle size distribution modes of particles are formed, e.g., an Apollonianistic particle size distribution, and the desired internal phase ratio is obtained.

In embodiments, a method disclosed herein may further comprise combining the emulsion produced with a carrier fluid and/or with a proppant or other component to produce a treatment fluid; and circulating the treatment fluid into a wellbore.

In embodiments, any one or combination of methods disclosed herein may further comprise forming a pack comprising the proppant and/or particulates present in the fluid along with the particles comprising the aqueous fluid provided by an embodiment of the emulsion disclosed herein in a subterranean location (i.e., downhole).

In embodiments, a method may further comprise contacting the pack with an acid, or with a fluid having a pH of less than about 2, in an amount, and for a time sufficient to remove at least a portion of the particles comprising the aqueous fluid from the pack to form a permeable pack. In embodiments, the permeable pack is produced by inverting the emulsion particles to release or destroy the discrete particles, thus producing voids in the pack. The method may further include producing or injecting a fluid through the permeable pack.

As is evident from the disclosure herein, a variety of embodiments are contemplated:
1. A method comprising: forming a composite emulsion comprising a plurality of particle size distribution modes of aqueous phase particles dispersed in an oil-based fluid; and manipulating the particle size distribution modes of the composite emulsion and a volume fraction of the oil-based fluid in the composite emulsion, to obtain high internal phase ratio invert emulsion comprising a dispersed particle volume fraction of greater than about 60 volume percent, based on the based on the total volume of the high internal phase ratio invert emulsion.
2. The method of embodiment 1, further comprising: combining a plurality of water-in-oil emulsions, each combined emulsion comprising one or more of the plurality of particle size distribution modes to form the composite emulsion; and removing a portion of the oil-based fluid from the composite emulsion to increase a dispersed particle volume fraction in the high internal phase ratio invert emulsion.
3. The method of embodiment 1 or embodiment 2, further comprising dispersing oil-based fluid in the aqueous phase of one or more of the particle size distribution modes, wherein the high internal phase ratio invert emulsion comprises an oil-in-water-in-oil emulsion.
4. The method of any one of embodiments 1 to 3, further comprising: combining an initial aqueous fluid portion with at least a portion of the oil-based fluid in the presence of an initial surfactant system under an initial amount of mixing energy to produce an initial emulsion comprising aqueous fluid particles having an initial particle size distribution mode dispersed in the oil-based fluid; combining a first successive aqueous fluid portion with the initial emulsion in the presence of a first successive surfactant system under a first successive amount of mixing energy to produce a first successive composite emulsion comprising aqueous fluid particles having a first successive particle size distribution mode dispersed in the oil-based fluid; and selecting the initial and first successive surfactant systems and amounts of mixing energy to produce successively larger particle size distribution modes from the initial emulsion to the first successive composite emulsion.
5. The method of embodiment 4, further comprising: combining one or more subsequent successive aqueous fluid portions with a respective immediately preceding one of the first or subsequent successive composite emulsions, in the presence of one or more respective subsequent successive surfactant systems under one or more respective subsequent successive amounts of mixing energy, to produce the respective one of the one or more subsequent successive composite emulsions, each comprising aqueous fluid particles having a respective subsequent successive particle size distribution mode dispersed in the oil-based fluid; and selecting the one or more subsequent successive surfactant systems and amounts of mixing energy to produce successively larger particle size distribution modes from the first successive composite emulsion to an ultimate one of the one or more subsequent successive composite emulsions.
6. The method of embodiment 4 or embodiment 5, further comprising removing a portion of the oil-based fluid from one of the initial or first or subsequent successive emulsions or a combination thereof to increase a dispersed particle volume fraction in the respective initial, first or subsequent successive emulsion.
7. The method of any one of embodiments 4 to 6, wherein each of the first and subsequent successive particle size distribution modes is from about 1.5 to 25 times larger than the respective one of the next preceding initial, first and subsequent successive particle size distribution modes.
8. The method of any one of embodiments 1 to 7, wherein the high internal phase ratio invert emulsion comprises a dispersed particle volume fraction of greater than or equal to about 65 volume percent, or greater than or equal to about 70 volume percent, or greater than or equal to about 75 volume percent, or greater than or equal to about 80 volume percent, or greater than or equal to about 85 volume percent, or greater than or equal to about 90 volume percent, or greater than or equal to about 95 volume percent, based on the based on the total volume of the emulsion.
9. The method of any one of embodiments 1 to 8, wherein one or more of the initial and first and subsequent successive surfactant systems comprise from about 0.1 to about 20 weight percent, by weight of the respective one of the initial and first and subsequent successive emulsions, of an amine surfactant having the structure:

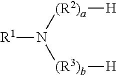

wherein R¹ is a hydrocarbyl comprising from 8 to 24 carbon atoms; wherein R² and R³ are independently selected from substituted or unsubstituted hydrocarbyl radicals comprising from 1 to 10 carbon atoms, ethylene oxide, propylene oxide, or a combination thereof; and wherein a+b is greater than or equal to 2.
10. The method of any one of embodiments 1 to 9, wherein one or more of the initial and first and subsequent successive surfactant systems comprise surfactant components differing from those of another one of the initial and first and subsequent successive surfactant systems.
11. The method of any one of embodiments 1 to 10, further comprising reversing the invert emulsion to form an oil-in-water emulsion.
12. The method of any one of embodiments 1 to 11, further comprising: introducing a proppant into the composite emulsion to produce a treatment fluid comprising the proppant dispersed in the high internal phase ratio invert emulsion; and circulating the treatment fluid into a wellbore.
13. The method of embodiment 12, further comprising forming a pack downhole comprising the proppant and at least a portion of the aqueous phase particles.
14. The method of embodiment 13, further comprising: contacting the pack with an acid in an amount sufficient to at least partially remove the aqueous phase particles from the pack to form a permeable pack; and producing a reservoir fluid or injecting an injection fluid through the permeable pack.
15. The method of embodiment 13 or embodiment 14, further comprising reversing the invert emulsion to form an oil-in-water emulsion.
16. A treatment fluid comprising the high internal phase ratio invert emulsion produced by the method of any one of embodiments 1 to 12.
17. An emulsion comprising: aqueous phase particles dispersed in a continuous oil-based phase and a surfactant system, the emulsion comprising a dispersed particle volume fraction of greater than about 60 volume percent, based on the based on the total volume of the emulsion.
18. The emulsion of embodiment 17, further comprising an internal oil-based phase dispersed in the aqueous phase to form an oil-in-water-in emulsion.
19. The emulsion of embodiment 17 or embodiment 18, wherein the aqueous fluid particles comprise a plurality of particle size distribution modes, wherein a first particle size distribution mode is from about 1.5 to 25 times larger than a second particle size distribution mode.
20. The emulsion of any one of embodiments 17 to 19, comprising a dispersed particle volume fraction of greater than or equal to about 75 volume percent, based on the based on the total volume of the emulsion.
21. The emulsion of any one of embodiments 17 to 19, comprising a dispersed particle volume fraction of greater than or equal to about 90 volume percent, based on the based on the total volume of the emulsion.
22. The emulsion of any one of embodiments 17 to 21, comprising from about 0.1 to about 20 weight percent of the surfactant system, wherein the surfactant system comprises an amine surfactant having the structure:

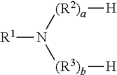

wherein R¹ is a hydrocarbyl comprising from 8 to 24 carbon atoms; wherein R² and R³ are independently selected from substituted or unsubstituted hydrocarbyl radicals comprising from 1 to 10 carbon atoms, ethylene oxide, propylene oxide, or a combination thereof; and wherein a+b is greater than or equal to 2.
23. The emulsion of any one of embodiments 17 to 22, wherein the surfactant system comprises a plurality of different surfactants.
24. The emulsion of any one of embodiments 17 to 23, wherein the emulsion is reversible to an oil-in-water emulsion.
25. A treatment fluid comprising: proppant dispersed in the emulsion of any one of embodiments 1 to 15.

While the embodiments have been illustrated and described in detail in the drawings and foregoing description, the same is to be considered as illustrative and not restrictive in character, it being understood that only some embodiments have been shown and described and that all changes and modifications that come within the spirit of the embodiments are desired to be protected. It should be understood that while the use of words such as ideally, desirably, preferable, preferably, preferred, more preferred or exemplary utilized in the description above indicate that the feature so described may be more desirable or characteristic, nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

We claim:

1. A method comprising:
forming a composite emulsion comprising a plurality of particle size distribution modes of aqueous phase particles dispersed in an oil-based fluid; and
manipulating the particle size distribution modes of the composite emulsion and a volume fraction of the oil-based fluid in the composite emulsion, to obtain high internal phase ratio invert emulsion comprising a dispersed particle volume fraction of greater than about 60 volume percent, based on the based on the total volume of the high internal phase ratio invert emulsion.

2. The method of claim 1, further comprising:
combining a plurality of water-in-oil emulsions, each combined emulsion comprising one or more of the plurality of particle size distribution modes to form the composite emulsion; and
removing a portion of the oil-based fluid from the composite emulsion to increase a dispersed particle volume fraction in the high internal phase ratio invert emulsion.

3. The method of claim 1, further comprising dispersing oil-based fluid in the aqueous phase of one or more of the particle size distribution modes, wherein the high internal phase ratio invert emulsion comprises an oil-in-water-in-oil emulsion.

4. The method of claim 1, further comprising:
combining an initial aqueous fluid portion with at least a portion of the oil-based fluid in the presence of an initial surfactant system under an initial amount of mixing energy to produce an initial emulsion comprising aqueous fluid particles having an initial particle size distribution mode dispersed in the oil-based fluid;
combining a first successive aqueous fluid portion with the initial emulsion in the presence of a first successive surfactant system under a first successive amount of mixing energy to produce a first successive composite emulsion comprising aqueous fluid particles having a first successive particle size distribution mode dispersed in the oil-based fluid; and
selecting the initial and first successive surfactant systems and amounts of mixing energy to produce successively larger particle size distribution modes from the initial emulsion to the first successive composite emulsion.

5. The method of claim 4, further comprising:
combining one or more subsequent successive aqueous fluid portions with a respective immediately preceding one of the first or subsequent successive composite emulsions, in the presence of one or more respective subsequent successive surfactant systems under one or more respective subsequent successive amounts of mixing energy, to produce the respective one of the one or more subsequent successive composite emulsions, each comprising aqueous fluid particles having a respective subsequent successive particle size distribution mode dispersed in the oil-based fluid; and
selecting the one or more subsequent successive surfactant systems and amounts of mixing energy to produce successively larger particle size distribution modes from the first successive composite emulsion to an ultimate one of the one or more subsequent successive composite emulsions.

6. The method of claim 5, further comprising removing a portion of the oil-based fluid from one of the initial or first or subsequent successive emulsions or a combination thereof to increase a dispersed particle volume fraction in the respective initial, first or subsequent successive emulsion.

7. The method of claim 5, wherein each of the first and subsequent successive particle size distribution modes is from about 1.5 to 25 times larger than the respective one of the next preceding initial, first and subsequent successive particle size distribution modes.

8. The method of claim 7, wherein the high internal phase ratio invert emulsion comprises a dispersed particle volume fraction of greater than about 90 volume percent, based on the based on the total volume of the emulsion.

9. The method of claim 5, wherein one or more of the initial and first and subsequent successive surfactant systems comprise from about 0.1 to about 20 weight percent, by weight of the respective one of the initial and first and subsequent successive emulsions, of an amine surfactant having the structure: 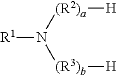
wherein R¹ is a hydrocarbyl comprising from 8 to 24 carbon atoms; wherein R² and R³ are independently selected from substituted or unsubstituted hydrocarbyl radicals comprising from 1 to 10 carbon atoms, ethylene oxide, propylene oxide, or a combination thereof; and wherein a+b is greater than or equal to 2.

10. The method of claim 5, wherein one or more of the initial and first and subsequent successive surfactant systems comprise surfactant components differing from those of another one of the initial and first and subsequent successive surfactant systems.

11. The method of claim 1, further comprising reversing the invert emulsion to form an oil-in-water emulsion.

12. The method of claim 1, further comprising:
introducing a proppant into the composite emulsion to produce a treatment fluid comprising the proppant dispersed in the high internal phase ratio invert emulsion; and
circulating the treatment fluid into a wellbore.

13. The method of claim 12, further comprising forming a pack downhole comprising the proppant and at least a portion of the aqueous phase particles.

14. The method of claim 13, further comprising:
contacting the pack with an acid in an amount sufficient to at least partially remove the aqueous phase particles from the pack to form a permeable pack; and
producing a reservoir fluid or injecting an injection fluid through the permeable pack.

15. The method of claim 13, further comprising reversing the invert emulsion to form an oil-in-water emulsion.

16. A treatment fluid comprising the high internal phase ratio invert emulsion produced by the method of claim 1.

17. An emulsion comprising:
aqueous phase particles dispersed in a continuous oil-based phase and a surfactant system, the emulsion comprising a dispersed particle volume fraction of greater than about 60 volume percent, based on the based on the total volume of the emulsion.

18. The emulsion of claim 17, further comprising an internal oil-based phase dispersed in the aqueous phase to form an oil-in-water-in emulsion.

19. The emulsion of claim 17, wherein the aqueous fluid particles comprise a plurality of particle size distribution modes, wherein a first particle size distribution mode is from about 1.5 to 25 times larger than a second particle size distribution mode.

20. The emulsion of claim 17, comprising a dispersed particle volume fraction of greater than or equal to about 75 volume percent, based on the based on the total volume of the emulsion.

21. The emulsion of claim 17, comprising a dispersed particle volume fraction of greater than or equal to about 90 volume percent, based on the based on the total volume of the emulsion.

22. The emulsion of claim 17, comprising from about 0.1 to about 20 weight percent of the surfactant system, wherein the surfactant system comprises an amine surfactant having the structure: 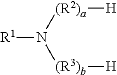
wherein R¹ is a hydrocarbyl comprising from 8 to 24 carbon atoms; wherein R² and R³ are independently selected from substituted or unsubstituted hydrocarbyl radicals comprising from 1 to 10 carbon atoms, ethylene oxide, propylene oxide, or a combination thereof; and wherein a+b is greater than or equal to 2.

23. The emulsion of claim 17, wherein the surfactant system comprises a plurality of different surfactants.

24. The emulsion of claim 17, wherein the emulsion is reversible to an oil-in-water emulsion.

25. A treatment fluid comprising:
proppant dispersed in an emulsion comprising aqueous phase particles dispersed in a continuous oil-based phase and a surfactant system, the emulsion comprising a dispersed particle volume fraction of greater than about 60 volume percent, based on the based on the total volume of the emulsion.
